(19) United States
(12) Patent Application Publication
(10) Pub. No.: US 2006/0233418 A1
(43) Pub. Date: Oct. 19, 2006

(54) Loudspeaker with low-frequency oscillation

(76) Inventor: Jui-Chen Huang, Bade City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/387,728

(22) Filed: Mar. 24, 2006

(30) Foreign Application Priority Data
Apr. 18, 2005 (TW) 94112316

(51) Int. Cl. H04R 11/02

(52) U.S. Cl. 381/417

(57) ABSTRACT

A loudspeaker with low-frequency oscillation, comprising: a housing (21) with a ring portion (211) extending inwardly from the bottom thereof; and a reed element (22) having a top end attached to an oscillatable sound assembly, the reed element (22) further having an external ring (221) and two vibration arms (222) symmetrically extending from the internal side of the external ring (221) to the internal side of the loudspeaker in a bent manner, each of the vibration arms (222) having a free end (223) extending to the center of the reed element (22), the oscillatable sound assembly including either a magnetic ring (25) or a coil (28) disposed within the housing (21), the ring portion (211) being attached to either another coil corresponding to the magnetic ring (25) or another magnetic ring corresponding to the coil (28), whereby, when the coil (28) is fed with electric current, a magnetic force is created to impart an up and down vibration to the oscillatable sound assembly, thereby enhancing the effect of the low-frequency sound field as well as the resonance effect.

### BACKGROUND OF THE INVENTION

1. Field of the Invention

The invention relates to a loudspeaker, and more particularly, to a minitype loudspeaker with low-frequency oscillation.

2. Description of the Related Art

A conventional minitype loudspeaker, as disclosed by a Japanese company CITIZEN, in TW 515219 as well as TW 515218 (U.S. Pat. No. 6,690,809 B2 and U.S. Pat. No. 6,400,825 B1) includes a diaphragm that produces sound by means of vibration. The circumference of the diaphragm is secured to a top housing. The longer the diameter of the diaphragm is, the lower sound is produced. The short the diameter of the diaphragm is, the higher sound is produced. However, the diameter of the diaphragm of the earphone loudspeaker is dependent on the dimensions of the housing of the earphone. Thus, it is difficult to produce low-frequency sound.

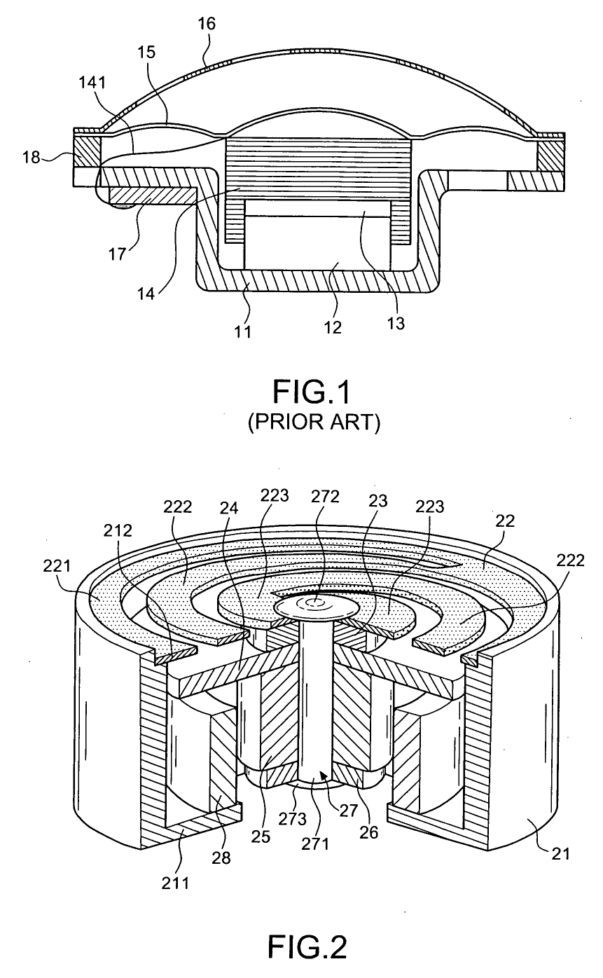

As shown in FIG. 1, an earphone loudspeaker disclosed in TW 504099 includes a base 11 with a groove formed at the center thereof. A magnet 12, a front pole piece 13, a sound ring 14, a diaphragm 15, and a protection cover 16 are placed into the groove one after another. A terminal plate 17 is attached to the bottom side of the base 11. Therefore, two wires 141 of the sound ring 14 can be extended to be welded onto the terminal plate 17. A metal ring 18 is pre-adhered to the rim of the diaphragm 15 while the ring rim of the base 11 has an open flat portion. Meanwhile, the diaphragm 15, the metal ring 18 and the protection cover 16 are so extended that they adjust to the dimensions of the base 11. In this way, the diaphragm 15 is flush with the flat portion along the ring rim of the base 11. As a result, the sound range can be extended by expanding the dimensions of the diaphragm 15.

However, the diameter of the diaphragm 15 is still dependent on that of the base 11. Thus, it is difficult to produce low-frequency sound and to provide a better audio effect.

In taking the shortcomings of the above-mentioned earphone loudspeaker into account, which cannot produce lower sound and provide a better response effect, the invention focuses on research and innovation to settle the above-mentioned problems.

### SUMMARY OF THE INVENTION

A primary object of the invention to provide a loudspeaker with low-frequency oscillation that has a longer oscillation element under the condition of the same area of the housing for producing a low-frequency resonance effect, creating a low-frequency sound, and therefore enhancing the response effect.

Another object of the invention to provide a loudspeaker that produces low-frequency oscillation and exerts a massaging effect on the human ear of the user in addition to generating low-frequency sound.

In order to reach the above-mentioned objects, a loudspeaker with low-frequency oscillation comprises:

a) a housing with a ring portion extending inwardly from the bottom thereof; and

b) a reed element having a top end attached to an oscillatable sound assembly, the reed element further having an external ring and two vibration arms symmetrically extending from the internal side of the external ring to the internal side of the loudspeaker in a bent manner, each of the vibration arms having a free end extending to the center of the reed element, the oscillatable sound assembly including either a magnetic ring or a coil disposed within the housing, the ring portion being attached to either another coil corresponding to the magnetic ring or another magnetic ring corresponding to the coil,

whereby, when the coil is fed with electric current, a magnetic force is created to impart an up and down vibration to the oscillatable sound assembly, thereby enhancing the effect of the low-frequency sound field as well as the resonance effect.

### BRIEF DESCRIPTION OF THE FIG.S

FIG. 1 is a cutaway view of a conventional earphone loudspeaker;

FIG. 2 is a perspective sectional view of a first preferred embodiment of the invention;

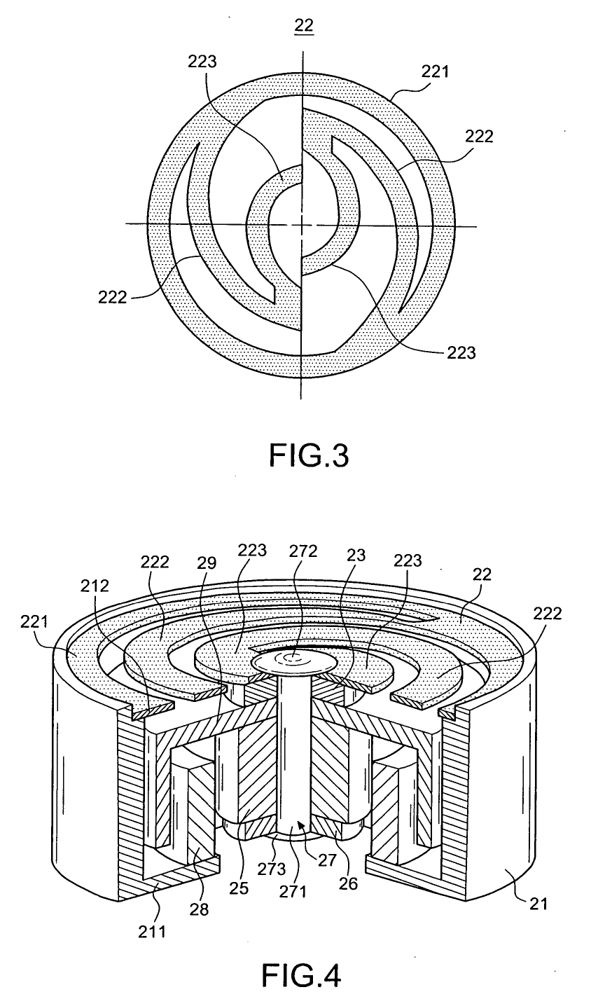

FIG. 3 is a top view of the reed element in accordance with the invention;

FIG. 4 is a perspective sectional view of a second preferred embodiment of the invention in;

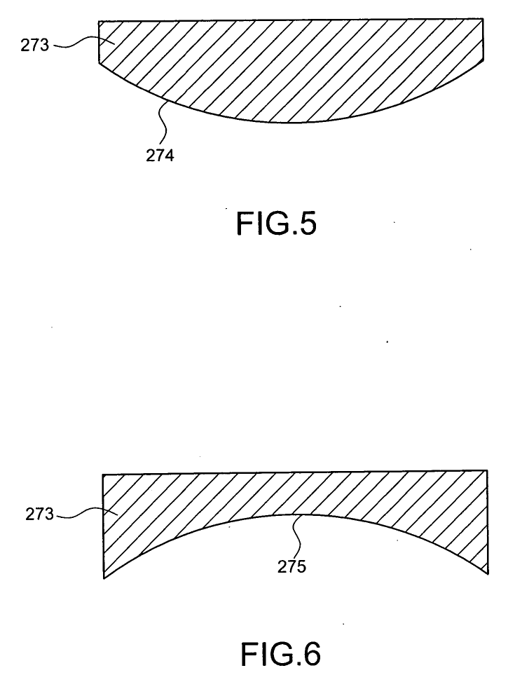

FIG. 5 is a sectional view of a first embodiment of the top head of the shaft body;

FIG. 6 is a sectional view of a second embodiment of the bottom head of the shaft body;

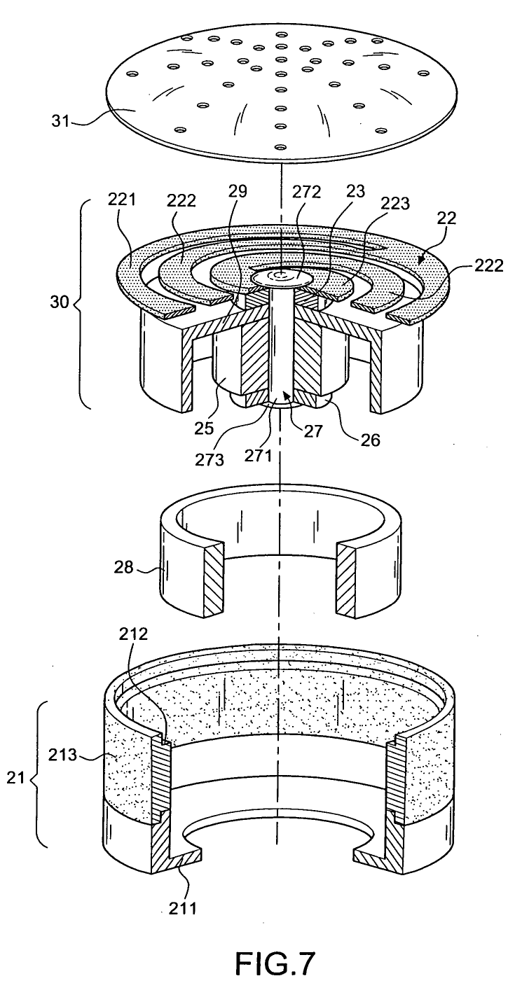

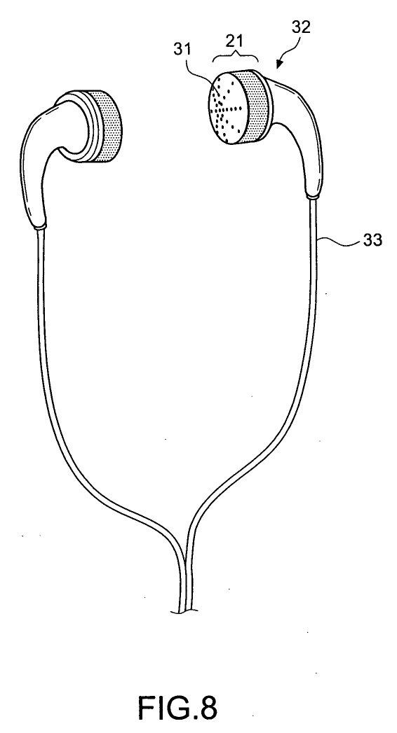

FIG. 7 is a perspective sectional view of a second preferred embodiment of the invention; and

FIG. 8 is a perspective view of the invention applied to an earphone.

### DETAILED DESCRIPTION OF THE PREFERRED EMBODIMENT

Referring to FIGS. 2 and 3, a loudspeaker with low-frequency oscillation in accordance with a first embodiment of the invention includes a housing 21 with a ring portion 211 extending inwardly from the bottom of the housing 21 and a grooved support portion 212 extending inwardly from the top thereof; and a reed element 22 with an external ring 221 and two vibration arms 222 symmetrically extending from the internal side of the external ring 221 to the internal side of the loudspeaker in a bent manner. Each of the vibration arms 222 includes a free end 223 extending to the center of the reed element 22, as shown in FIG. 3.

An upper ring 23, a sound element 24, a magnetic ring 25, and a lower ring 26 are disposed one after another under the free end 223 of the reed element 22 within the housing 21. The sound element 24 includes a central through hole. A shaft body 27 includes a pin 271 combining the central holes of the upper ring 23, the sound element 24, the magnetic ring 25, and the lower ring 26 one after another into one body. The shaft body 27 has a top head 272 and a bottom head 273 resting on the top side of the free end 223 of the vibration arms 222 and the bottom side of the lower ring 26, respectively. In this way, the reed element 22, the upper ring 23, the sound element 24, the magnetic ring 25, the lower ring 26 and the shaft body 27 can be combined into an oscillatable sound assembly. The sound element 24 is disc-shaped. One of the top head 272 and the bottom head 273 is integrally formed with the shaft body 27 while the other head is secured by its screw portion to a threaded hole of the shaft body 27 or attached to the shaft body 27 by means of a wedge type portion. Alternatively, the bottom head 273 may be integrally formed with the lower ring 26. A coil 28 corresponding to the magnetic ring 25 is fitted to the top of the external ring 221. When the coil 28 is fed with electric current, a magnetic force can be produced to impart an up and down oscillation to the magnetic ring 25 of the oscillatable sound assembly. Meanwhile, the sound element 24 will be synchronically oscillated as well to produce sound.

The external ring of the sound element 24 is formed in such a way different from the conventional diaphragm 15 fixed at the internal side of the housing 21 and having no direct contact to the internal side of the housing 21. The vibrating force of the sound element 24 is provided by the vibration arms 222 of the reed element 22. Since the vibration arms 222 are extended inwardly from the external ring 221 in a bend way, it is not necessary to adjust the length of the vibration arms 222 to the diameter of the housing 21. In this way, the length of the vibration arms 222 may exceed the diameter of the housing 21. Under the condition of the same diameter of the housing 21, the vibration arms 222 in accordance with the invention has a greater oscillation range than the conventional diaphragm. As a result, a low-frequency sound field can be created to achieve a better response effect. Moreover, the vibration arms 222 in accordance with the invention can respond to the low-frequency resonance, thereby ensuring a desired low-frequency oscillation effect of the whole loudspeaker. When the loudspeaker is installed within an earphone that is placed into a human ear, the earphone will create oscillation to exert a massaging effect to the ear wearing the earphone. The present invention is not characterized in the relative position between the coil 28 and the magnetic ring 25, but in the special design of the reed element 22. In addition to the aforementioned embodiment, the magnetic ring 25 can be attached to the ring portion 211 of the housing 21 while the coil 28 is secured to the shaft body 27 (not shown). This can also achieve the same effect and won't be described more hereinafter.

FIG. 4 illustrates a second embodiment of the loudspeaker with low-frequency oscillation in accordance with the invention. The second embodiment corresponds substantially to the loudspeaker of the first embodiment except that the sound element 29 is formed in a cylindrical shape differently from the platelike sound element 24, and the cylindrical wall of the sound element 29 surrounds the coil 28 and the magnetic ring 25. As shown in FIG. 5, the bottom head 273 of the shaft body 27 includes a convex portion 274 at the bottom thereof. In this way, the sound field created by the speaker will expand to a wider range.

As shown in FIG. 6, the bottom head 273 includes a concave portion 275 at the bottom thereof. In this way, the sound field created by the speaker can be concentrated at a certain position.

FIG. 7 shows a perspective view of a second embodiment of the invention in accordance with FIG. 4. As shown in FIG. 7, the coil 28 can be firstly secured to the housing 21. Thereafter, the reed element 22, the upper ring 23, the sound element 29, the magnetic ring 25, and the lower ring 26 of the oscillatable sound assembly are mounted on the shaft body 27 to create a composite unit 30 which is then placed into the housing 21. Thus, the assembly in accordance with FIG. 4 is formed. Meanwhile, the upper portion 213 of the housing 21 can be made of elastic material like silicon while the ring portion 211 of the lower portion of the housing 21 can be made of hard material. Then, the upper and the lower portion of the housing 21 are combined together. In this way, when the reed element 22 vibrates, a vibrating movement can be imparted to the upper portion 213 of the housing 21, thereby increasing the vibrating and massaging effect of the whole body. Furthermore, a protection cover 31 is disposed on the top surface of the housing 21 (see FIG. 8), thereby creating a minitype earphone 32 that are placed directly outside of the ear canal. After connecting a lead wire 33 to the rear side of the minitype earphone 32, the minitype earphone 32 can be inserted into the ear to listen to music. The minitype earphone 32 has small dimensions due to the unique design of the reed element 22 of the invention. Meanwhile, the low-frequency oscillation effect can be achieved to improve the audio quality when listening to music.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A loudspeaker with low-frequency oscillation, comprising:
a) a housing (21) with a ring portion (211) extending inwardly from the bottom thereof; and
b) a reed element (22) having a top end attached to an oscillatable sound assembly, the reed element (22) further having an external ring (221) and two vibration arms (222) symmetrically extending from the internal side of the external ring (221) to the internal side of the loudspeaker in a bent manner, each of the vibration arms (222) having a free end (223) extending to the center of the reed element (22), the oscillatable sound assembly including either a magnetic ring (25) or a coil (28) disposed within the housing (21), the ring portion (211) being attached to either another coil corresponding to the magnetic ring (25) or another magnetic ring corresponding to the coil (28), whereby, when the coil (28) is fed with electric current, a magnetic force is created to impart an up and down vibration to the oscillatable sound assembly, thereby enhancing the effect of the low-frequency sound field as well as the resonance effect.

2. The loudspeaker with low-frequency oscillation as recited in claim 1 further comprising an upper ring (23), a sound element (24), a magnetic ring (25), and a lower ring (26), wherein the sound element (24) includes a central through hole, and wherein a shaft body (27) includes a pin (271) combining the central holes of the upper ring (23), the sound element (24), the magnetic ring (25), and the lower ring (26) one after another, and wherein the shaft body (27) has a top head (272) and a head resting on the top side of the free end (223) of the vibration arms (222) and the bottom side (273) of the lower ring (26), respectively, whereby the reed element (22), the upper ring (23), the sound element (24), the magnetic ring (25), the lower ring (26) and the shaft body (27) can be combined into one body, and wherein the ring portion is coupled to the coil (28) corresponding to the magnetic ring (25).

3. The loudspeaker with low-frequency oscillation as recited in claim 1 further comprising an upper ring (23), a sound element (24), a magnetic ring (25), and a lower ring (26), wherein the sound element (24) includes a central through hole, and wherein a shaft body (27) includes a pin (271) combining the central holes of the upper ring (23), the sound element (24), the magnetic ring (25), and the lower ring (26) one after another, and wherein the shaft body (27) has a top head (272) and a bottom head (273) resting on the top side of the free end (223) of the vibration arms (222) and the bottom side of the lower ring (26), respectively, whereby the reed element, the upper ring (23), the sound element (24), the magnetic ring (25), the lower ring (26) and the shaft body (27) can be combined into one body, and wherein the ring portion (22) is coupled to the magnetic ring (25) corresponding to the coil (28).

4. The loudspeaker with low-frequency oscillation as recited in claim 2 wherein the sound element (24) is formed in a disc shape.

5. The loudspeaker with low-frequency oscillation as recited in claim 2 wherein the sound element (29) is formed in a cylindrical shape, and wherein the cylindrical wall surrounds the coil (28) and the magnetic ring (25).

6. The loudspeaker with low-frequency oscillation as recited in claim 2 wherein either the top head (272) or the bottom head (273) is integrally formed with the shaft body (27).

7. The loudspeaker with low-frequency oscillation as recited in claim 2 wherein the reed element includes two symmetrically bent vibration arms (222).

8. The loudspeaker with low-frequency oscillation as recited in claim 2 wherein the bottom head (273) and the lower ring (26) are integrally formed.

9. The loudspeaker with low-frequency oscillation as recited in claim 2 wherein the bottom head (273) has a convex portion (274) at the bottom thereof.

10. The loudspeaker with low-frequency oscillation as recited in claim 2 wherein the bottom head (273) has a concave portion (275) at the bottom thereof.
